(19) United States
(12) Patent Application Publication
(10) Pub. No.: US 2026/0357627 A1
(43) Pub. Date: Nov. 12, 2026

(54) Sliding Door Gear

(71) Applicant: SAMET KALIP VE MADENI ESYA SANAYI VE TICARET A.S., Istanbul (TR)

(72) Inventors: Artur Hirtsiefer, Neunkirchen-Seelscheid (DE); Himmet Tanriverdi, Istanbul (TR); Evren Urak, Istanbul (TR)

(21) Appl. No.: 19/474,840

(22) PCT Filed: May 31, 2023
(86) PCT No.: PCT/TR2023/050496

§ 371 Date: Oct. 13, 2025

(51) Int. Cl. E05D 15/10

(52) U.S. Cl. CPC E05D 15/1065; E05Y 2900/20

(57) ABSTRACT

The invention relates to a sliding door gear (110) comprising at least one door mount (165) for mounting at least one sliding door (6, 7) to a stationary structure, the door mount (165) being movable between a closed and an open position via an intermediate position, wherein the door mount (165) comprises a guide element (169) at least temporarily guided by a rail (160). Reliable guidance of a sliding door and a simple mechanical design are achieved in that a guide track (131) and a further guide track (171) on a retractable track member (170), movable along the first opening direction (D1) between an extended and a retracted position, are provided, and in that the guide element (169), during a movement of the door mount (165) between the closed and the intermediate position, is guided by both the guide track (131) and the further guide track (171) at least temporarily.

The invention relates to a sliding door gear comprising at least one door mount for mounting at least one sliding door to a stationary structure, such as a door frame or a piece of furniture, in particular a cabinet, wherein the door mount can be moved from a closed position to an open position via an intermediate position, wherein the intermediate position is offset from the closed position in the first opening direction, wherein the door mount can be moved from the intermediate position to the open position in a second opening direction transverse to the first opening direction, wherein the door mount comprises a guide element, and wherein the door mount, at least during part of its movement along the second opening direction, is guided with its guide element by a rail.

A door mount being in the closed position may correspond to a sliding door attached thereto being in a closed state. If a stationary structure, in particular a cabinet, is provided with more than one sliding door, front planes of the sliding doors may lie in a common plane, when in the closed state.

A door mount being in the intermediate position may correspond to a sliding door attached thereto being in an intermediate state. Further, a door mount being in the open position may correspond to a sliding door attached thereto being in an open state.

The first opening direction may be a direction facing away from the cabinet. In particular, the first opening direction may be parallel to a surface normal of a front of a sliding door. The second opening direction may be arranged to be substantially parallel to the stationary structure and/or be perpendicular to the surface normal of a front plane of a sliding door. Preferably, both opening directions may be horizontal. However, it is also conceivable that at least the second opening direction is vertical, which may in particular be the case for cabinets with sliding doors that open and/or close in an upward/downward manner. Generally, a direction along the first or second opening direction may not be restricted to a direction in the first or second opening direction, but may also include a direction against the first or second opening direction, respectively.

DE 36 19 775 A1 discloses a cabinet with sliding doors. The sliding doors are mounted to the cabinet by means of door mounts comprising rollers that are guided on rails provided on top of the cabinet. When the sliding doors are in a closed state, their front planes are parallel. In order to provide for opening of the sliding doors, the cabinet is equipped with two types of sliding doors, wherein a first type is movable toward an intermediate state, where it is located in a plane offset from the front of the cabinet. A second type of sliding door is not movable to this intermediate state but only slidable along the cabinet. Further, both types of sliding doors are attached, in a lower region thereof, to a lower door mount. The first type is additionally pivotably connected to a linkage. Both the lower door mount and the linkage are provided with rollers that are guided in a common guide rail located below the cabinet. When the first type door is moved between its intermediate and closed state, the roller connected to the lower door mount is guided out of the guide rail trough an opening, while the roller connected to the linkage remains within the guide rail, which is enabled by pivoting of the linkage. For the second type door, an additional guide rail is provided below the cabinet.

A disadvantage of the known design described above is that two guide rails need to be provided such that different types of doors can be opened. Further, the design necessitates provision of separate rollers connected to the sliding door of the first type in its lower region, one of which needs to change its distance from the door, and the other one of which needs to exit the guide rail when the door is moved to its closed state. As a consequence, such a design is quite complicated and requires a large number of moving parts.

The technical problem solved by the invention is to provide a sliding door gear that enables reliable guidance of a sliding door with a simple mechanical design.

The problem is solved in that a guide track and a further guide track are provided, in that the guide element, during at least part of a movement of the door mount between the closed and the intermediate position, is guided by both the guide track and the further guide track, and in that the further guide track is provided on a retractable track member which is movable along the first opening direction between an extended position and a retracted position. Preferably, the guide track and the further guide track are movable relative to one another.

This way, there is no need to provide for different types of guide elements that perform different types of movement when the door mount is moved between the closed and the intermediate position. Furthermore, the guide track and the further guide track may ensure secure guidance of the guide element.

A sliding door gear according to the invention may be particularly suitable to be provided in a lower region of the stationary structure, in particular below a bottom wall of a cabinet. Consequently, the sliding door gear of the invention may be referred to as a lower sliding door gear.

An advantageous variant of the invention may be characterized in that the retractable track member is in its retracted position when the door mount is in its closed position, and in that the retractable track member is in its extended position when the door mount is in between and including its intermediate and open position.

A sliding door gear according to the invention may be characterized in that regions of the guide track and the further guide track engaging with the guide element are aligned with one another, when the door mount is in between and including its intermediate and open position. If it is further provided that regions of the guide track and the further guide track engaging with the guide element intersect one another, when the door mount is in its closed position and preferably at least during parts of a travel between the closed position and the intermediate position, the door mount may be securely held in the closed position and guided between the intermediate and closed positions. Preferably, regions of the guide track and the further guide track engaging with the guide element intersect one another, when the door mount is in between its closed position and up to but not including the intermediate position.

A smooth transition of the guide element between the rail and the guide track may be achieved in that the second opening direction is parallel or tangential to a first portion of the guide track adjoining an inlet of the guide track. In particular, the inlet of the guide track may be provided adjacent to a longitudinal end of the rail. If it is further provided that the second opening direction is transverse to a second portion of the guide track, wherein preferably the guide track comprises a transitional portion which transitions the first portion into the second portion, movability of the door mount between its intermediate and closed positions may be achieved in a simple manner. Further, the door mount may, in its closed position, be effectively secured against movement along the second opening direction.

In this context, it may preferably be provided that the guide element is engaged with the second portion, when the door mount is in its closed position, and that the guide element is engaged with the first portion, when the door mount is in its intermediate position. The further guide track may, in its extended position, be aligned with the first portion of the guide track, and, in its retracted position, offset therefrom along the first opening direction.

If it is provided that the further guide track is parallel to the second opening direction at least in regions, the guide element may be guided along the second opening direction by both the further guide track and the rail and/or the guide track along at least a part of a travel of the door mount between its intermediate and open positions.

According to a preferred variant of the invention, the region of an inlet of the further guide track may be provided with an inlet widening, which widens a transverse width of the further guide track, preferably gradually, along the second opening direction toward the inlet of the further guide track. This may reduce the necessary accuracy of an alignment of the further guide track with the rail and/or the guide track.

A compact and mechanically robust design of the sliding door gear may be achieved in that the guide track and the further guide track are arranged in planes following one another in a direction transverse to the first opening direction and the second opening direction, preferably in a vertical direction.

Guiding of the guide element by both the guide track and the further guide track may be achieved in a space-saving manner, if it is provided that the guide element extends through the further guide track to engage with the guide track, in particular to extend into the guide track.

A particularly simple design of the retractable track member that may also be cost-effective in manufacture may be achieved if the retractable track member is plate-shaped at least in the region of the further guide track, and if the further guide track is configured as a slot formed through the retractable track member.

Secure and well-defined movability of the retractable track member between its retracted and extended positions may be achieved in that a retraction assembly is provided, in that the retractable track member is coupled to the retraction assembly, and in that the retraction assembly provides for movability of the retractable track member between its extended and retracted positions.

In this context, it may additionally be provided that the retraction assembly comprises a retraction guide, in that the retraction guide comprises a stationary mount and a retracting member, in that the retracting member is guided by the stationary mount to be movable in the first opening direction, and in that the retractable track member is coupled to the retracting member.

To achieve reduced wear and gentle running of the retracting member relative to the stationary mount it is proposed that the retracting member is guided on the stationary mount by a linear guide, in that the linear guide is formed by a guide slot at least partially aligned with the first opening direction and guide members, preferably rollers, that are guided at the guide slot, wherein the guide slot is provided on the retracting member and the guide elements are provided on the stationary mount and/or vice versa.

A preferred embodiment of the invention may be characterized in that an actuating device is provided, which is urges the retractable track member along the first opening direction toward the extended position at least along part of its way between the retracted and the extended position. In this way, the actuating device can provide for or at least support a movement of the door mount from its closed to its intermediate position.

Additionally or alternatively, the actuating device may urge the retractable track member along the first opening direction toward the retracted position at least along part of its way between the extended and the retracted position. In this way, the actuating device can provide for or at least support a closing movement of the door mount from its intermediate to its closed position.

The invention also relates to a stationary structure, in particular a cabinet, to which at least one sliding door is mounted by means of a sliding door gear as described above, wherein a further sliding door gear is provided, wherein one of the sliding door gear and the further sliding door gear, preferably the further sliding door gear, is provided in an upper region of the stationary structure, in particular on a top wall of a cabinet, providing for attachment of the sliding door in an upper region thereof, wherein the other one of the sliding door gear and the further sliding door gear, is provided in a lower region of the stationary structure, in particular below a bottom wall of a cabinet, providing for attachment of the sliding door in a lower region thereof, and wherein a synchronizing device is provided, which synchronizing device synchronizes the movement of the further guide track to the movement of a component of the further sliding door gear along the first opening direction.

The invention will be further described by way of example with reference to the drawings, in which:

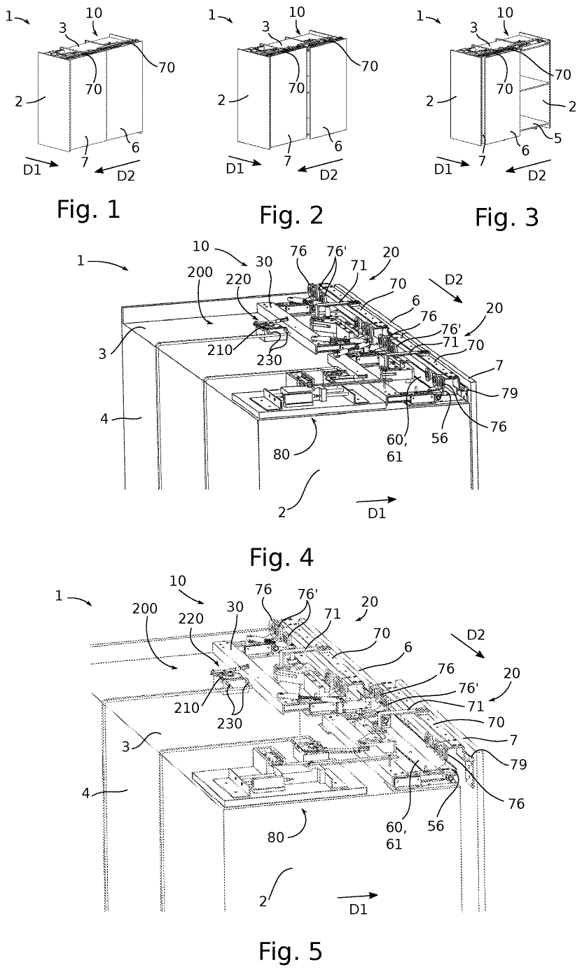

FIG. 1 is a perspective view of a cabinet with two sliding doors in a closed state and a sliding door gear,

FIG. 2 is a perspective view of the cabinet with one of the sliding doors in an intermediate state,

FIG. 3 is a perspective view of the cabinet with one of the sliding doors in an open state and the other of the sliding doors in the closed state,

FIG. 4 is a further perspective view of the cabinet with both sliding doors in a closed state,

FIG. 5 is a further perspective view of the cabinet with one of the sliding doors in an intermediate state,

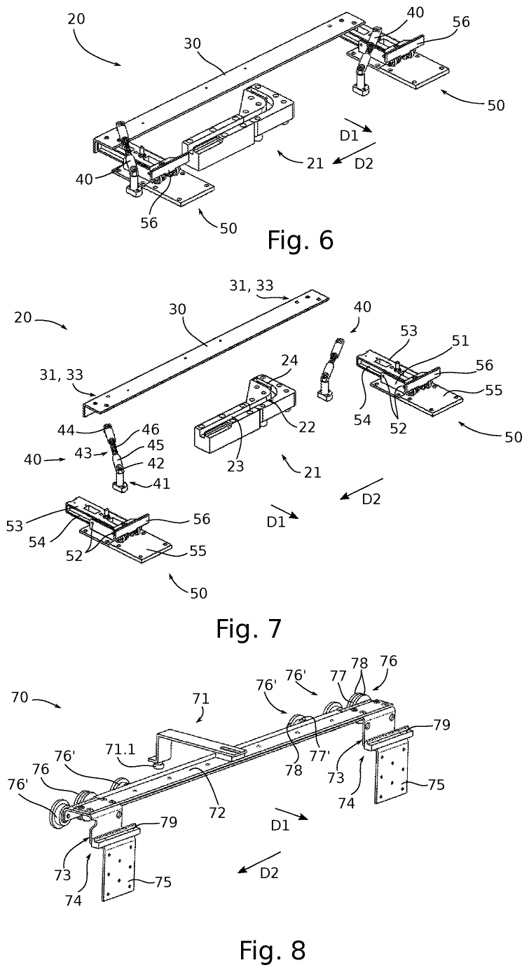

FIG. 6 is a perspective view of a retraction assembly,

FIG. 7 is an exploded perspective view of a retraction assembly,

FIG. 8 is a perspective view of a door mount,

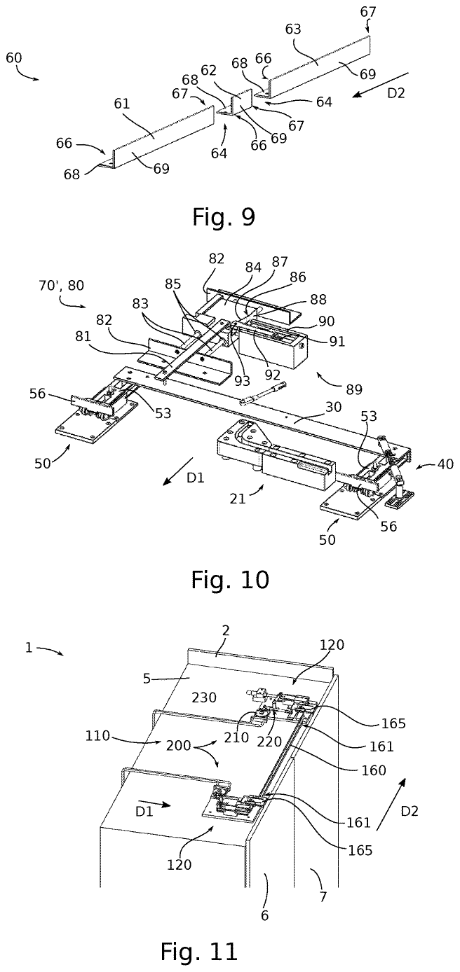

FIG. 9 is a perspective view of stationary rail segments,

FIG. 10 is a perspective view of a retraction assembly and a retaining assembly

FIG. 11 is a perspective view of a lower sliding door gear,

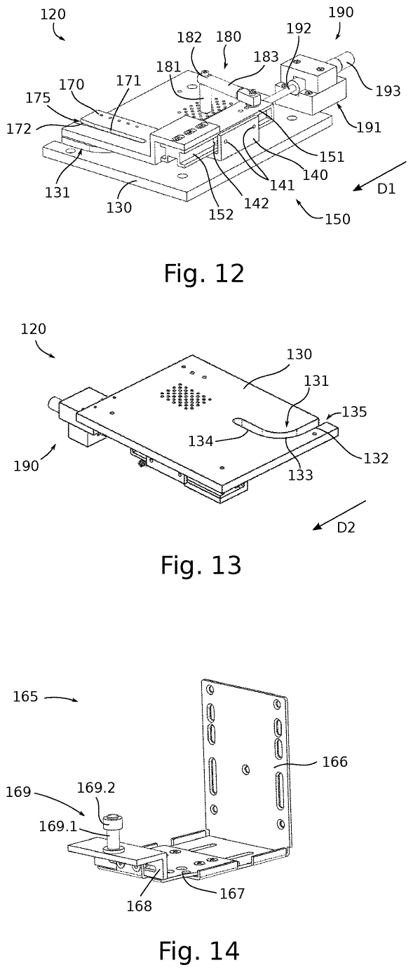

FIG. 12 is a perspective view of a lower retraction assembly,

FIG. 13 is a further perspective view of the lower retraction assembly, and

FIG. 14 is a perspective view of a lower door mount.

FIG. 1 shows a perspective view of a cabinet 1 to which a sliding door gear 10 is mounted. The sliding door gear 10 comprises two door mounts 70, to each of which a sliding door 6, 7 is mounted, respectively. Thereby, the sliding doors 6, 7 are mounted to the cabinet 1.

The cabinet 1 may comprise a bottom wall 5, a top wall 3, two side walls 2 and a rear wall 4. As shown in the figures, the sliding door gear 10 may be provided in an upper region of the stationary structure, in particular on a top wall (3) of a cabinet (1), providing for attachment of the sliding door (6, 7) in an upper region thereof, Consequently, the sliding door gear 10 may be referred to as an upper sliding door gear 10.

As will be discussed in more detail further below, there may be provided a further sliding door gear 110 provided in a lower region of the stationary structure, in particular below a bottom wall (5) of a cabinet (1), providing for attachment of the sliding door (6, 7) in a lower region thereof, which may be referred to as a lower sliding door gear 110.

The door mounts 70, may be movable between a closed position and an open position. FIG. 1 shows both sliding doors 6, 7 in a closed state. A closed state of a sliding door 6, 7 may correspond to its respective door mount 70 being in a closed position.

In FIG. 2, the sliding door 6 is shown in an intermediate state. In this intermediate state, the sliding door 6 may be displaced relative to its closed state in first opening direction D1, which may be a direction facing away from the cabinet 1, in particular, as shown in FIG. 2, a direction normal to a front face of the sliding door 6. While the sliding door 6 is in the intermediate state, the door mount 70 may be in its intermediate position.

In FIG. 4, the upper sliding door gear 10 is visible in more detail. As can be gathered from this figure, the sliding doors 6, 7 may be connected to the door mounts 70. FIG. 8 provides a more detailed view of a door mount 70. Accordingly, the door mount 70 may comprise a main body 72, which may comprise a longitudinal plate shaped element. The main body 72 may comprise a longitudinal extension along the second opening direction D2 that may be less than and/or correspond to a longitudinal extension of a sliding door 6, 7 attached thereto.

Further, the door mount 70 may comprise at least one door attachment section 75. In the embodiment shown, the door mount 70 comprises two door attachment sections 75 spaced apart along the second opening direction D2. The door attachment section 75 may comprise suitable attachment means to attach the door 6, 7 to the door mount 70. For example, as shown, the door attachment section 75 may comprise bores through which screws can be guided to engage with the sliding door 6, 7.

The door mount 70 may further comprise at least one guide element 76. According to the embodiment shown, the door mount 70 comprises two guide elements 76. The guide elements 76 may be provided in the form of wheels or rollers that may be held at the door mount 70 in a manner rotatable about axes that may be parallel to the first opening direction D1. Consequently, the door mount 70 may, by means of its guide elements 76, roll on a rail 60 of the upper sliding door gear 10 (cf. FIGS. 4, 5, 9). Preferably, the guide elements 76 may be provided on a side of the main body 72 that is facing away from the door attachment section 75 and/or from a sliding door 6, 7 attached thereto. In particular, the guide elements 76 may be provided on a side of the main body 72 that is facing against the first opening direction D1.

The guide elements 76 may comprise a circumferential running portion 77. The running portion 77 may form a guide receptacle that may at least partially receive a section of the rail 60 the guide element 76 is rolling on. Preferably, the guide receptacle is designed such that it engages over the rail 60 with support sections 78 on opposite longitudinal sides of the rail 60. As can be seen in FIG. 8, the support sections 78 may be in the form of flanges.

Additionally, there may be provided at least one, in particular as shown, multiple further guide elements 76′. The further guide elements 76′ may be designed similar to the guide elements 76. However, it may be preferable that circumferential further running portions 77′ of the further guide elements 76′ form a guide receptacle which is open towards at least one longitudinal side of the rail 60. In the embodiment shown, the guide receptacle formed by the further running portions 77′ is open on a side facing in the first opening direction D1. More specifically, the further guide elements 76 may comprise a support section 78, in particular a flange, on their sides facing against the first opening direction D1, but no support section 78 on their sides facing in the first opening direction D1.

As can further be gathered from FIG. 8, at least one further movable rail segment 79 may be provided on the door mount 70. The further movable rail segment 79 may be designed to selectively replace a movable rail segment 56 that may be connected to a retraction assembly 20, as will be explained in more detail further below. Preferably, the further movable rail segment 79 may be provided on a side of the main body 72 facing in the first opening direction D1, in particular on a side of the main body 72 facing away from the cabinet 1 and/or toward a sliding door 6, 7 attached to the door mount 70.

As in the present embodiment, the further movable rail segment 79 may be provided in vicinity of the door attachment section 75. In particular, it may be provided that the door attachment section 75 is provided on a plate shaped member which is connected to the main body 72. The plate shaped member may comprise an angled part 73 that is angled relative to the main body 72, preferably at a right angle. Following the angled part 73, the plate shaped member may comprise a step section 74 angled off therefrom, preferably at a right angle, on which step section 74 the further movable rail segment 79 may be held. The door attachment section 75 may be again angled off from the step section 74 and be arranged in vicinity thereto.

Preferably, there may be two further movable rail segments 79 provided on the door mount 70. The further movable rail segments 79 may have a longitudinal extension along the second opening direction D2 that is less than the longitudinal extension of the door mount 70, in particular less than a longitudinal extension of the main body 72 of the door mount 70.

Further, the door mount 70 may comprise an attachment section 71 provided with a guide component 71.1. The attachment section 71 may be in the form of an arm extending from the main body 72 against the first opening direction D1, in particular extending toward the cabinet 1. In an end region of the attachment section 71 facing away from the door mount 70, the guide component 71.1 may be held. Preferably, the guide component 71.1 may be designed as a roller that is rotatable about an axis transverse to the first and second opening directions D1, D2, in particular about a vertical axis. The guide component 71.1 may be at least temporarily guided by a guide track 22, which will be discussed in more detail further below.

Referring back to FIG. 4, the upper sliding door gear 10 further comprises a rail 60. The rail 60 may be arranged on the top wall 3 of the cabinet 1. The rail 60 may comprise at least one stationary rail segment 61. The embodiment shown in the drawings features three stationary rail segments 61, 62, 63, which is best visible in FIG. 9. Preferably, the stationary rail segments 61 may be arranged such that they are aligned with one another along the second opening direction D2.

The stationary rail segments 61, 62, 63 may be designed as angled members comprising a bottom section 68 and an angled section 69. The bottom section 68 may be arranged for mounting to the cabinet 1, in particular the top wall 3. The bottom section 68 may therefore comprise suitable fixing means, such as bores through which screws may be guided to engage with the top wall 3. The angled section 69 may be angled off from the bottom section 68, preferably at a right angle. The angled section 69 may be provided to engage with the guide elements 76 and/or the further guide elements 76′.

As can be further seen in FIG. 9, the stationary rail segments 61, 62, 63 may be arranged such that gaps 64 are formed in between neighboring stationary rail segments 61, 62, 63. In particular, the gaps 64 may be formed in between longitudinal ends 66, 67 of stationary rail segments 61, 62, 63. The upper sliding door gear 10 may be designed such that the gaps 64 may be selectively bridged by movable rail segments 56 and/or further movable rail segments 79, which will be discussed in more detail below.

Referring back again to FIG. 4, it can be understood that the upper sliding door gear 10 may further comprise at least one retraction assembly 20. The embodiment shown comprises two retraction assemblies 20, which may be essentially similar in design. Each retraction assembly 20 may be associated with one of the sliding doors 6, 7. Discussion of the retraction assemblies 20 will be first based on the retraction assembly 20 shown at the far end of the cabinet 1 in FIG. 4, which is shown in more detail in FIGS. 6 and 7.

Turning first to FIG. 6, it is evident that the retraction assembly 20 may comprise at least one movable rail segment 56. The movable rail segment 56 may be movable along the first opening direction D1 between an idle position and a working position. The idle position may be offset from the working position in a direction against the first opening direction D1. FIG. 6 shows the movable rail segments 56 being in their idle positions.

Movability of the movable rail segment 56 may be achieved by means of a retraction guide 50, which is better visible in the exploded view of FIG. 7. Consequently, the retraction guide 50 may comprise a base plate 55 that may be adapted to be mounted on the stationary structure, in particular on the top wall 3 of the cabinet 1. The retraction guide 50 may further be equipped with a stationary mount 51 and a retracting member 53. The stationary mount 51 may be in the form of a bracket fixed to the base plate 55. The retracting member 53 may be arranged such that it is guided by the stationary mount 51 along the first opening direction D1. In particular, as shown in the drawings, the retracting member 53 may comprise a guide slot 54 that may be arranged parallel to the first opening direction D1. The stationary mount 51 may comprise guide elements, in particular rollers, which may be rotatably held at axles 52 mounted to the stationary mount 51. The guide elements may roll at/on/in the guide slot 54. Consequently, a linear guide may be provided between the stationary mount 51 and the retracting member 53.

The movable rail segment 56 may be connected to the retracting member 53. In particular, it may be fixed to the retracting member 53 at an end region thereof facing in the first opening direction D1.

As in the embodiment shown, the retraction assembly 20 may comprise two retraction guides 50, each comprising a retracting member 53 to each of which a movable rail segment 56 is fixed. The retraction guides 50 may be spaced apart from one another along the second opening direction D2. As can further be seen in FIGS. 6 and 7, a connecting part 30 may be provided to connect the retracting members 53 to one another. The connecting part 30 may therefore be a provided with fixing sections 33 in its opposing longitudinal end regions 31, with which it can be secured to the retracting members 53. The connecting part 30 may thus be movable together with the retracting members 53 and the movable rail segments 56 attached thereto along the first opening direction D1.

The retraction assembly 20 may further comprise at least one actuating device 40. The actuating device 40 may comprise a base part 41 that may be secured to the stationary structure, in particular to the top wall 3 of the cabinet 1. However, it is also conceivable to secure the base part 41 to the base plate 55 of the retraction guide 50. A pivotable part 43 may be pivoted to the base part 41 at a joint part 42 so as to be pivotable about an axis transverse to the first and second opening directions D1, D2, in particular about a vertical axis. The pivotable part 43 may comprise a support part 45 that may be provided adjacent to the joint part 42. Further, at an end of the pivotable part 43 opposing the joint part 42, there may be provided a coupling part 44. The support part 45 and the coupling part 44 may be displaceable relative to one another along a longitudinal direction of the pivotable part 43. Preferably, the relative displacement is biased by a spring element 46 between the support part 45 and the coupling part 44. In particular, the spring element 46 may be a compression spring.

The coupling part 44 may preferably be coupled to the connecting part 30. However, it is also conceivable that the coupling part 44 may be coupled to the retracting member 53 of the retraction guide 50. Consequently, a movement of the movable rail segments 56 between their idle and working positions may, by means of a pivoting of the pivotable part 43, provoke a relative movement of the support part 45 and the coupling part 44 to one another.

As can be further seen in FIGS. 6 and 7, a draw-in arrangement 21 may be arranged in the region of the retraction assembly 20 and/or be a part of the retraction assembly 20. The draw-in arrangement 21 may be shaped as a block in which a guide track 22 in the form of a slot is provided. The guide track 22 may provide for guidance of the guide component 71.1 provided on the attachment section 71 of the door mount 70, as indicated above.

The guide track 22 may comprise a straight portion 23 that may be essentially parallel to the second opening direction D2. The straight portion 23 may transition into an angled portion 24. The angled portion 24 may be transverse to the straight portion 23, in particular essentially parallel to the first opening direction D1.

As indicated above, both retraction assemblies 20 shown in FIG. 4 may be essentially similar in design. However, the retraction assembly 20 shown at the close end of the cabinet 1 in FIG. 4 is coupled to a retaining assembly 80. The retraction assembly 20 and the associated retaining assembly 80 is shown in more detail in FIG. 10. The retaining assembly 80 may comprise a connecting member 81 which may be connected on one end to a moving component of the retraction assembly 20, in particular to the connecting part 30 connecting the retracting members 53 of the retraction guides 50. On its other end, the connecting member 81 may be coupled to a cam part 84.

The cam part 84 may be movable along the first opening direction D1. To achieve movability, the cam part 84 may be guided on guide rods 83. For this purpose, the cam part 84 may be provided with guide receptacles 85, in particular bores, which may contain guide elements such as rollers and/or a bushing. In particular, the guide rods 83 may be provided stationary to the stationary structure and may be arranged parallel to the first opening direction D1. As shown in FIG. 10, the guide rods 83 may be held at opposing ends by mounting plates 82 that may be mounted to the stationary structure, in particular to the top wall 3 of the cabinet 1.

The cam part 84 may comprise a cam section 86 which may comprise an inclined section 87 and a retaining section 88. The inclined section 87 may follow the retaining section 88 in the first opening direction D1. The retaining section 88 may comprise a flat surface, a surface normal of which may be parallel to the second opening direction D2 or at least slightly inclined thereto such that it comprises a component against the first opening direction D1. The inclined section 87 may comprise a flat surface, a surface normal of which may be at least slightly inclined to the second opening direction D2 such that it comprises a component in the first opening direction D1.

The cam section 86 may be provided to be at least partially and/or temporarily in contact with a tappet head 93 of a tappet 92. The tappet 92 may be supported by a tappet mount 89 and may be movable in a direction towards and from the cam part 84, preferably in a direction along the second opening direction D2. The tappet 92 may be biased toward the cam part 84 by a spring 91. In particular, the tappet 92 may be partially received in the tappet receptacle 90 with a section facing away from its tappet head 93. The spring 91 may also at least partially be held within the tappet receptacle 90. The tappet head 93 may preferably comprise a roller rotatable about an axis perpendicular to the second opening direction D2 and the first opening direction D1, preferably about a vertical axis.

As will be explained in more detail below, the retaining assembly 80 may provide functions similar to those of the actuating device 40 discussed before. However, as seen in FIG. 10, the retraction assembly 20 may be associated with both a retaining assembly 80 and an actuating device 40.

Turning now to FIG. 11, it is evident that a further sliding door gear 110 may be provided. The further sliding door gear 110 may be provided in a lower region of the stationary structure, in particular as shown below a bottom wall 5 of the cabinet 1. Consequently, it may be referred to as lower sliding door gear 110.

As can be gathered from FIG. 11, the lower sliding door gear 110 may comprise a rail 160, which may essentially be aligned parallel to the second opening direction D2. The rail 160 may provide for guiding guide elements 169 that are associated with a door mount 165 connected to a sliding door 6, 7 in a lower region thereof.

A more detailed view of a door mount 165 is provided in FIG. 14. The door mount 165 may comprise a door attachment section 166 that may enable securing the door mount 165 to the sliding door 6, 7. For example, the door attachment section 166 may be essentially plate shaped and comprise slots and/or bores through which fixing elements such as screws may be guided to engage with the sliding door 6, 7.

Angled off from the door attachment section 166, the door mount 165 may comprise a first adjustment section 167. The first adjustment section 167 may provide for an adjustability of a distance of the guide element 169 from the door attachment section 166 along the first opening direction D1. The first adjustment section 167 may be designed as a telescoping sliding guide, as shown in the present embodiment.

Further, the door mount 165 may comprise a second adjustment section 168, which may be displaceable relative to the first adjustment section 167 in a direction along the second opening direction D2. Thereby, the guide element 169 may be adjustable relative to the door attachment section 166 along the second opening direction D2. Preferably, the guide element 169 is provided on the second adjustment section 168.

The guide element 169 may comprise a shaft portion 169.1 and a roller portion 169.2. The roller portion 169.2 may comprise a larger outer circumference than the shaft portion 169.1. The roller portion 169.2 may be held at the shaft portion 169.1 in a manner rotatable about an axis transverse to the first and second opening directions D1, D2, preferably about a vertical axis.

As shown in FIG. 11, the lower sliding door gear 110 may comprise at least one retraction assembly 120. The embodiment of the drawings comprises two retraction assemblies 120. A more detailed view of a retraction assembly 120 is provided in FIGS. 12 and 13.

The retraction assembly 120 may comprise a base plate 130 that may be mounted in a stationary manner to the stationary structure, in particular to a bottom wall 5 of the cabinet 1. A guide track 131 may be provided on the retraction assembly 120, in particular may be formed as a slot within the base plate 130. As best visible in FIG. 13, the guide track 131 may comprise an inlet 135 which leads into a first portion 132 of the guide track 131. The first portion 132 may be substantially parallel and/or tangential to the second opening direction D2. A transitional portion 133 may be provided transitioning the first portion 132 into a second portion 134. The second portion 134 of the guide track 131 may be arranged transverse to the first portion 132, in particular essentially parallel to the first opening direction D1.

Referring now to FIG. 12, it is evident that the retraction assembly 120 may further comprise a further guide track 171. The further guide track 171 may be provided on a retractable track member 170. Preferably, the further guide track 171 may be provided as a slot within the retractable track member 170. The retractable track member 170 may be plate-shaped in the region of the further guide track 171. The retractable track member 170 may be provided to be movable along the first opening direction D1 between an extended position and a retracted position. In FIG. 12, the retractable track member 170 is shown in a position in between its extended and retracted positions.

As in the embodiment shown in the drawings, the retractable track member 170 may be arranged below the base plate 130 in a vertical direction in a typical installation situation. In other words, the guide track 131 may be provided above the further guide track 171.

The further guide track 171 may be provided with an inlet widening 172 in the region of its inlet 175, which gradually widens the transverse width of the slot towards the inlet 175.

Movability of the retractable track member 170 may be provided by a retraction guide 150. In particular, the retractable track member 170 may be connected to a retracting member 151. The retracting member 151 may be guided by a stationary mount 140 of the retraction guide 150. The stationary mount 140 may be secured to the base plate 130. Preferably, the retracting member 151 may comprise a guide slot 152 that may be arranged essentially parallel to the first opening direction D1. The guide slot 152 may form a linear guide in conjunction with guide members 142 that may be provided on the stationary mount 140. Preferably, the guide members 142 may be in the form of rollers rotatable about axles 141, which in particular may be arranged parallel to the second opening direction D2.

Movability of the retractable track member 170 against the first opening direction D1 may be limited by a stop member 192 bearing against the retracting member 151. Consequently, the retracted position of the retractable track member 170 may be determined by the position of the stop member 192 along the first opening direction D1. As shown in the embodiment of FIGS. 12 and 13, an adjustment device 190 may be provided to achieve adjustability of the position of the stop member 192. For instance, the adjustment device 190 may comprise a mounting part 191 at which the stop member 192 may be held. The stop member 192 may comprise an external thread that may engage in a threaded bore of the mounting part 191 so as to be axially adjustable by rotation. Adjustment of the stop member 192 by a user may then be facilitated by provision of an actuating portion 193, which may be a handle or a grip portion.

As can be further gathered from FIGS. 12 and 13, the retraction assembly 120 may be equipped with an actuating device 180. The design of the actuating device 180 of the retraction assembly 120 of the lower sliding door gear 110 may essentially correspond to the actuating device 40 of the retraction assembly 20 of the upper sliding door gear 10. Consequently, the actuating device 180 may comprise a base part 181 and a pivotable part 183 coupled thereto by a joint part 182. Preferably, the base part 181 may be fixed to the base plate 130 and the pivotable part 183 may be pivotably coupled to a movable part of the retraction assembly 120, such as the retracting member 151. The actuating device 180 may also comprise a spring at the pivotable part 183, albeit not visible in FIG. 12, and thus provide a similar spring-biased function as described above for the actuating device 40 of the retraction assembly 20 of the upper sliding door gear 10.

Referring back to FIG. 11, it can be gathered that the rail 160 may be aligned with the first portions 132 of the retraction assemblies 120 such that a largely continuous transition between the rail 160 and the inlets 135 of the guide tracks 131 is achieved. The door mount 165 may thus be selectively guided in the rail 160 and the guide track 131, preferably with its roller portion 169.2.

It should be noted that, when the retractable track member 170 is in its extended position, the further guide track 171 may be aligned with first portion 132 of the guide track 131. In this situation, the guide element 169 may be guided along the second opening direction D2 into and/or out of and/or guided within both the guide track 131 and the further guide track 171. In particular, the guide element 169 may engage through the further guide track 171. More particularly, the shaft portion 169.1 may be operatively engaged with the further guide track 171 and the roller portion 169.2 may be operatively engaged with the guide track 131.

As discussed before, the stationary structure, in particular the cabinet 1 may be provided with an upper sliding door gear 10 and a lower sliding door gear 110. In order to achieve synchronous movement a sliding door 6, 7 both in its upper and lower region, in particular movement along the first opening direction D1, a synchronizing device 200 may be provided.

As can be seen in FIG. 4, the synchronizing device 200 may comprise a pulley 210. The pulley 210 may be rotatable about an axis transverse to the first and second opening directions, in particular about a vertical axis. A flexible transmission member, in particular a cable, may be guided around the pulley 210, such that a rotation of the pulley 210 may be translated into a linear movement of the cable along its longitudinal axis. Preferably, the flexible transmission member is fixed to the pulley by suitable fixing means, for instance clamped against the pulley by a bolt.

The cable may be guided from a pulley 210 associated to the upper sliding door gear 10 to a pulley 210 associated with the lower sliding door gear 110, cf. FIG. 11. Consequently, rotational movement of the pulleys 210 in the upper and lower region of the cabinet 1 may be synchronized by cable. The cable may be a single cable, in particular a closed loop cable. Most preferably, two cables may be provided. The cables may be guided from the upper region to the lower region through cable housings 230.

The pulleys 210 may be connected to movable parts of the retraction assemblies 20, 120 such that a movement along the first opening direction D1 is translated into a rotation of the pulleys 210. As seen in FIGS. 4 and 5, a lever mechanism 220 may be provided that may be pivotably coupled, at its one end, to the pulley 210 and, at its other end, to the movable part, in particular the connecting part 30 of the retraction assembly 20 of the upper sliding door gear 10.

Similarly, as seen in FIG. 11, the pulley 210 in the lower region may be connected to the retractable track member 170 by means of a similar lever mechanism 220.

In the following, the operation of the upper sliding door gear 10 and the lower sliding door gear 110 will be described by way of example referring to the embodiment shown in the figures.

In FIG. 4, both sliding doors 6, 7 are shown in their closed states and their associated door mounts 70 are in their closed positions. Meanwhile, the movable rail segments 56 the associated retraction assemblies 20 are in their idle positions. In their idle positions, the movable rail segments 56 are retracted from the stationary rail segments 61 of the rail 60 against the first opening direction D1. The guide elements 76 of the door mount 70 rest on the movable rail segments 56. At least some of the further guide elements 76′, however, may not rest on the movable rail segment 56 and rather be free from contact with the rail 60.

However, the further movable rail segments 79 provided on the door mount 70 replace the stationary rail segments 61 in such a way that they take their place in bridging gaps 64 and/or elongating stationary rail segments 61 in their longitudinal ends 66, 67. This means that a largely continuous rail 60 is provided by means of the stationary rail segments 61 and the further movable rail segments 79.

Regarding the lower sliding door gear 110, when the door is in the closed state, the lower door mount 165 is in its closed position. In this situation, the retractable track member 170 is in its retracted position. When the retractable track member 170 is in the retracted position, the guide track 131 and the further guide track 171 are not aligned with one another, but intersect in the area of the guide element 169.

Returning to the upper sliding door gear 10, when the door mount 70 is now moved from the closed position to its intermediate position in the first opening direction D1, the movable rail segments 56 are moved in the first opening direction D1 toward their working position together with the guide elements 76 and the door mount 70. Simultaneously, the further movable rail segments 79, being provided on the door mount 70, are being offset from the rail 60 in the first opening direction D1. In other words, the movable rail segments 56 take the place of the further movable rail segments 79 along the rail 60.

The further guide elements 76′, their running portion 77′ not being delimited on the side facing in the first opening direction D1 by a support section 78, are moved onto the rail 60, in particular onto a stationary rail segment 61, 62, 63.

Consequently, when the sliding door 6, 7 is in the intermediate state, its door mount 70 rests with its guide elements 76 and further guide elements 76′ on the rail 60 which is largely continuous by alignment of the stationary rail segments 61, 62, 63 and the movable rail segments 56. This is shown for sliding door 7 in FIG. 5.

Turning now to the lower sliding door gear 110, when the sliding door 6, 7 is moved from the closed to the intermediate state, the guide element 169 is moved along the guide track 131 along the first opening direction D1 until it reaches the first portion 132. Simultaneously, the retractable track member 170 is moved toward its extended position.

The movement of the retractable track member 170 of the lower sliding door gear 110 and the movable rail segments 56 of the upper sliding door gear 10 in the first opening direction D1 is synchronized by means of the synchronizing device 200 as explained above.

With reference to FIG. 5, it should be noted that, while the sliding door 7 is in the intermediate state, the other sliding door 6 is in its closed state, and therefore its assigned door mount 70 is in its closed position. This means that the further movable rail segments 79 provided on the door mount 70 of the other sliding door 6 provide, in conjunction with the stationary rail segments, a largely continuous rail in front of the main body 72 of the door mount 70 of the other sliding door 6. This provides the advantage that the sliding door 7 can be moved to its open state along, in the present case against, the second opening direction D2. The sliding door 7 can thus be moved in front of the other sliding door 6.

Once the sliding door 7 is in moved into its open state, i.e. in front of the other sliding door 6, it can be closed again, with the steps described above proceeding in reverse order.

Referring now to the function of the actuating device 40 of the upper sliding door gear 10, it should be noted that, depending on the arrangement, the actuating device 40 can provide the functions of retaining the door mount 70 in its closed position, of pulling the door mount 70 into its closed position, of pushing the door mount 70 into its intermediate position and/or of retaining the door mount 70 in its intermediate position. These functions may be achieved in the actuating device 40 retaining the movable rail segments 56 in their idle positions, of pulling the movable rail segments 56 into their idle position, of pushing the movable rail segments 56 into their working position and/or of retaining the movable rail segments 56 in their working position. A choice of the functions to be performed by the actuating device 40 can be made through the choice of position of a dead center position of the pivoting motion of the pivotable part 43 with respect to its pivot axis. In a similar way, this applies to the function of the actuating device 180 of the lower sliding door gear 110, being of similar design.

As indicated before, the retaining assembly 80 may provide similar functions to that of the actuating devices 40, 80. FIG. 10 may show the movable rail segments 56 in a retracted position, which may correspond to the door mount 70 being in its closed state. In this situation, the tappet head 93 may rest on the inclined section 87. If the door mount 70 is now moved to its intermediate position and, consequently, the movable rail segments 56 are moved from their idle to their working positions, the cam part 84 will be moved in the first opening direction D1. By engagement of the tappet head 93 along the inclined section 87, the tappet 92 is pushed into its tappet receptacle 90 against the force of the spring 91. Finally, when the movable rail segments 56 have reached their working positions, the tappet head 93 may rest against the retaining section 88 of the cam section 86. Depending on the choice of inclinations and/or positions and/or lengths of the inclined section 87 and/or the retaining section 88, the retaining assembly 80 can thus provide the functions of retaining the movable rail segments 56 in their idle positions, of pulling the movable rail segments 56 into their idle position, of pushing the movable rail segments 56 into their working position and/or of retaining the movable rail segments 56 in their working position.

1-15. (canceled)

16. A sliding door gear, comprising:
at least one door mount configured to mount at least one sliding door to a stationary structure, the door mount including at least one guide element;
a rail;
a guide track; and
a retractable track member including a further guide track, the retractable track member being movable in a first opening direction between a retracted position and an extended position;
wherein the door mount is movable from a closed position to an open position via an intermediate position;
wherein the intermediate position is offset from the closed position in the first opening direction;
wherein the door mount is movable from the intermediate position to the open position along a second opening direction transverse to the first opening direction and the door mount is guided during part of the movement along the second opening direction by engagement of the guide element with the rail; and
wherein the guide element is guided by both the guide track and the further guide track during at least part of a movement of the door mount between the closed position and the intermediate position.

17. The sliding door gear of claim 16, wherein:
the retractable track member is in the retracted position when the door mount is in the closed position; and
the retractable track member is in the extended position when the door mount is in between and including its intermediate and open positions.

18. The sliding door gear of claim 16, wherein:
a region of the guide track is aligned with a region of the further guide track when the door mount is in between and including its intermediate and open positions; and
the guide track and the further guide track intersect one another at a region of each of the guide track and the further guide track engaging with the guide element, when the door mount is in the closed position.

19. The sliding door gear of claim 18, wherein:
the guide track and the further guide track intersect one another at the region of each of the guide track and the further guide track engaging with the guide element, at least during part of a travel of the guide element between the closed position and the intermediate position.

20. The sliding door gear of claim 16, wherein the guide track includes:
a first portion adjoining an inlet of the guide track, the second opening direction being parallel or tangential to the first portion;
a second portion oriented transverse to the second opening direction; and
a transitional portion which transitions the first portion into the second portion.

21. The sliding door gear of claim 20, wherein:
the guide element is engaged with the second portion of the guide track when the door mount is in the closed position; and
the guide element is engaged with the first portion of the guide track when the door mount is in the intermediate position.

22. The sliding door gear of claim 16, wherein:
at least a portion of the further guide track is parallel to the second opening direction.

23. The sliding door gear of claim 16, wherein:
the further guide track includes an inlet and an inlet widening which widens a transverse width of the further guide track along the second opening direction toward the inlet.

24. The sliding door gear of claim 16, wherein:
the guide track and the further guide track are arranged in planes following one another in a direction transverse to both the first opening direction and the second opening direction.

25. The sliding door gear of claim 16, wherein:
the guide element extends through the further guide track to engage with the guide track.

26. The sliding door gear of claim 16, wherein:
the retractable track member is plate-shaped at least in a region of the further guide track; and
the further guide track is configured as a slot formed through the retractable track member.

27. The sliding door gear of claim 26, further comprising:
a retraction assembly coupled to the retractable track member for moving the retractable track member between the extended and retracted positions.

28. The sliding door gear of claim 27, wherein:
the retraction assembly includes a retraction guide including a stationary mount and a retracting member, the retracting member being guided by the stationary mount to be movable in the first opening direction; and
the retractable track member is coupled to the retracting member.

29. The sliding door gear of claim 28, wherein:
the retracting member is guided on the stationary mount by a linear guide;
the linear guide is formed by a guide slot at least partially aligned with the first opening direction and guide members guided in the guide slot; and
the guide slot is provided on one of the retracting member or the stationary mount and the guide members are provided on the other of the retracting member or the stationary mount.

30. The sliding door gear of claim 16, further comprising:
an actuating device configured to urge the retractable track member along the first opening direction toward the extended position at least along part of the movement between the retracted and extended positions.

31. The sliding door gear of claim 16, further comprising:
an actuating device configured to urge the retractable track member along the first opening direction toward the retracted position at least along part of the movement between the retracted and extended positions.

32. The sliding door gear of claim 16 in combination with the stationary structure, the combination further comprising:
at least one sliding door mounted on the stationary structure by the sliding door gear, wherein the sliding door gear is mounted on a bottom wall of the stationary structure;
a further sliding door gear mounted on a top wall of the stationary structure and connected to the sliding door; and
a synchronizing device configured to synchronize movement of the further guide track to a movement of a component of the further sliding door gear along the first opening direction.
